(19) United States
(12) Patent Application Publication
(10) Pub. No.: US 2011/0175817 A1
(43) Pub. Date: Jul. 21, 2011

(54) MOBILE TERMINAL

(76) Inventor: Tomonori Kuroda, Saitama (JP)

(21) Appl. No.: 12/671,899

(22) PCT Filed: Aug. 4, 2008
(86) PCT No.: PCT/JP2008/063953

§ 371 Date: Feb. 2, 2010

(30) Foreign Application Priority Data
Aug. 6, 2007 (JP) 2007-204182

(51) Int. Cl. G06F 3/02

(52) U.S. Cl. 345/169

(57) ABSTRACT

Portable terminal (20) of this invention includes image display portion (7) that displays an image, and key operation portion (8) that displays an image corresponding to a function and/or input keys (4a) corresponding to a function and that enables an input operation using input keys (4a). Key operation portion (8) includes transmission/diffusion switchable film (2) that transmits or diffuses light from light source (3).

### TECHNICAL FIELD

The present invention relates to a mobile terminal comprising an image display portion and a key operation portion.

### BACKGROUND ART

FIG. 1 is an exploded perspective view of a key operation portion of a mobile terminal of related art relating to the present invention.

A key operation portion shown in FIG. 1 includes operation keys 101, key operation portion housing panel 102, keypad 103, substrate 104, and illumination LEDs 105.

Operation keys 101 comprise ten keys, cursor keys, an enter key, a start key, an end call key, a clear key, and a menu key. Operation keys 101 are arranged on key operation portion housing panel 102. Illumination LEDs 105 are arranged on substrate 104 at positions corresponding to operation keys 101. Key operation portion housing panel 102 and substrate 104 are joined together with keypad 103 sandwiched therebetween.

Operation keys 101 are used to execute various tasks such as to dial a phone number; to create, delete, send, or read a message; to write an address in an address book or to read or delete an address from the address book; or to switch between various menus.

However, the following problems exist with the configuration that includes the operation keys.

A first problem is that because the operation keys can only be disposed in one kind of prescribed design, it is possible to use only the same key pattern for dial operations, character input operations, application operations, and the like, and consequently there is a disadvantage with respect to operability. This fact is one reason why some elderly people cannot utilize an e-mail function, and is also a reason why the mobile terminal is not sufficient with respect to changes in the appearance thereof.

A second problem is that the configuration produces an inferior illumination effect because light from illumination LEDs arranged in the key operation portion is only emitted from the key button portion.

A third problem is that because there are many constituent members, it is difficult to make the mobile terminal thinner.

A fourth problem is that in order to prevent illumination irregularities at the key operation portion it is necessary to install illumination LEDs that correspond with each operation key, respectively. This is disadvantageous in terms of the cost of the illumination LEDs and power consumption.

The problems described above can be solved by adopting a mobile terminal in which a touch panel is installed on an LCD (Liquid Crystal Display) of the image display portion.

This configuration can solve the first problem since operations are simplified by displaying patterns that are best suited to a dial operation, a character input operation, and an application operation, respectively, on the touch panel.

This configuration can also solve the second problem since it is possible to display a screen saver or the like that has an illumination effect on the image display portion, thus providing the mobile terminal with sufficient changes in appearance.

This configuration can also solve the third and fourth problems since operation keys and a large number of illumination LEDs are unnecessary. Japanese Patent Laid-Open No. 2004-348204 discloses a screen input-type display device that comprises a touch panel on a front surface side of a scattering type liquid crystal display panel including a light source on a rear surface. According to the aforementioned device, when the liquid crystal display panel is in an “off” state, the scattering type liquid crystal display panel and the light source are in an “on” state.

### SUMMARY OF INVENTION

However, even though a configuration in which a touch panel that is installed on an LCD of an image display portion employs a costly LCD, since the display properties deteriorate (brightness decreases, chromaticity deteriorates, and the like) when light is transmitted through the touch panel, the specifications of the properties of the LCD cannot be adequately exploited.

Thus, an object of the present invention is to provide a mobile terminal that offers excellent operability and an excellent illumination effect, that enables a reduction in thickness, that suppresses costs and power consumption, and that can adequately exploit the properties of the image display portion.

A mobile terminal of the present invention for achieving the above described object comprises:

an image display portion that displays an image; and

a key operation portion that displays a image pattern in accordance with a function,

and enables an input operation that uses the image pattern as input keys;

wherein the key operation portion includes a transmission/diffusion switchable film that transmits or diffuses a light from a light source.

The key operation portion of the mobile terminal of the present invention may comprise a touch panel that is provided in a laminated manner on the transmission/diffusion switchable film.

Further, the mobile terminal of the present invention may comprise a plurality of the transmission/diffusion switchable films, wherein each of the transmission/diffusion switchable films displays a different image pattern.

Furthermore, the mobile terminal of the present invention may be a mobile phone,

wherein, as the image pattern,
a dial screen for call origination is displayed when a call origination function is selected;
a screen on which characters for e-mail creation are arrayed is displayed when an e-mail creation function is selected; and
an operation key for the application is displayed when an application function is selected.

The mobile terminal of the present invention may be a terminal in which light of the key operation portion is used as illumination.

The mobile terminal of the present invention may comprise a transparent window on a side surface of the housing of the mobile terminal. In this case, light of the light source is emitted from the window, and thus the mobile terminal has an excellent illumination effect.

According to the present invention, a mobile terminal is provided that provides excellent operability and an excellent illumination effect, enables a reduction in thickness and suppression of costs and power consumption, and can sufficiently exploit the properties of an image display portion.

### BRIEF DESCRIPTION OF DRAWINGS

FIG. 1 is an exploded perspective view of a key operation portion of a mobile terminal according to art relating to the present invention;

FIG. 2A is an oblique perspective view that represents an external oblique perspective view of a mobile terminal as an exemplary embodiment;

FIG. 2B is an oblique perspective view that represents the basic configuration of a key operation portion of the mobile terminal as an exemplary embodiment;

FIG. 3 is an oblique perspective view that represents the basic configuration of a key operation portion that uses a linear light source as a light source;

FIG. 4 is an oblique perspective view that represents the basic configuration of a key operation portion that uses a surface light source as a light source;

FIG. 5A is a view that schematically shows a state of transmission/diffusion of light from a linear light source with respect to a transmission/diffusion film of the present invention;

FIG. 5B is a view that schematically shows a state of transmission/diffusion of light from a surface light source with respect to a transmission/diffusion film of the present invention;

FIG. 6 is a side sectional view of a key operation portion including a transmission/diffusion switchable film which consists of a plurality of transmission/diffusion switchable layers;

FIG. 7A is a view that illustrates an example of an image pattern that is displayed on a screen of the key operation portion;

FIG. 7B is a view that illustrates another example of an image pattern that is displayed on the screen of the key operation portion;

FIG. 8 is a flowchart for explaining operations of the key operation portion of the mobile terminal of the present invention;

FIG. 9 is a control block diagram of the mobile terminal of the present invention;

FIG. 10A is a view that illustrates a configuration in a case in which light that escapes from side surfaces of a transmission/diffusion switchable film is utilized as illumination; and

FIG. 10B is an external oblique perspective view of a mobile phone in which windows are provided at side surfaces.

### DESCRIPTION OF EMBODIMENTS

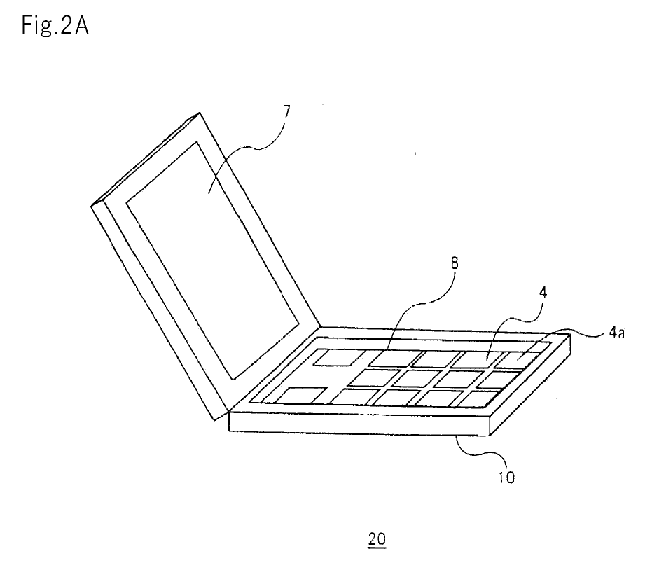

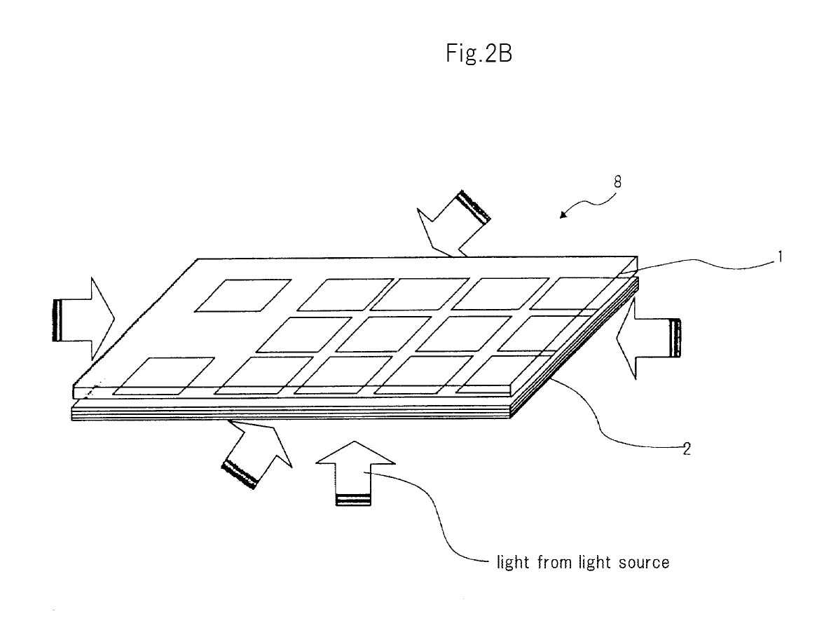

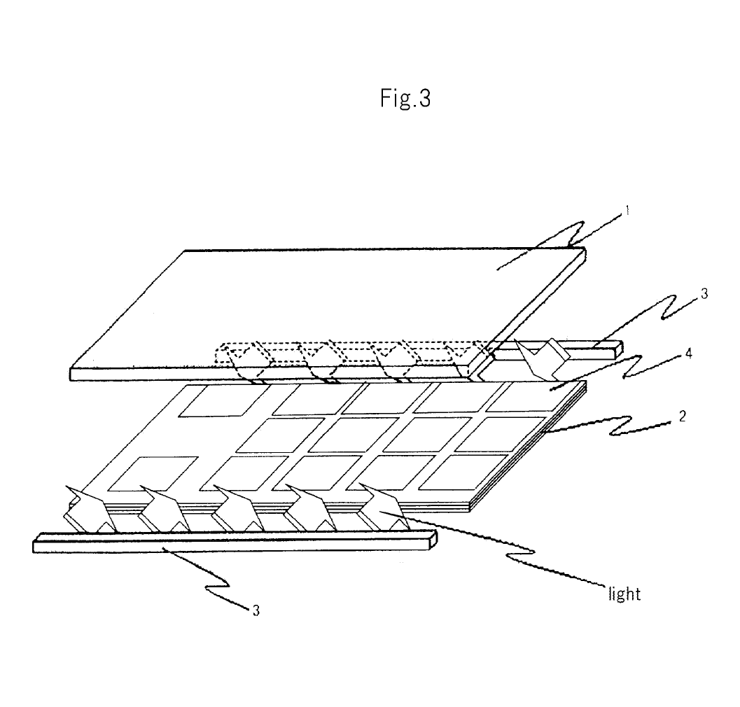

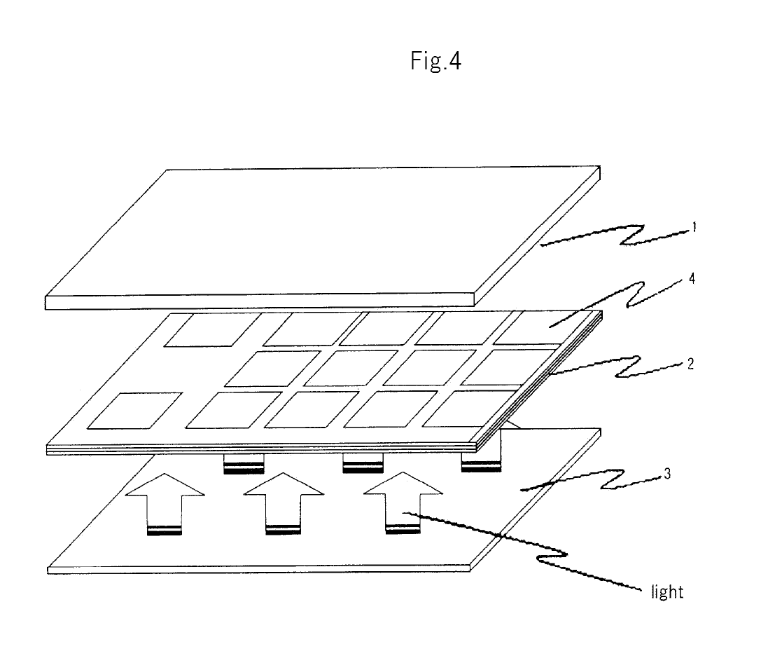

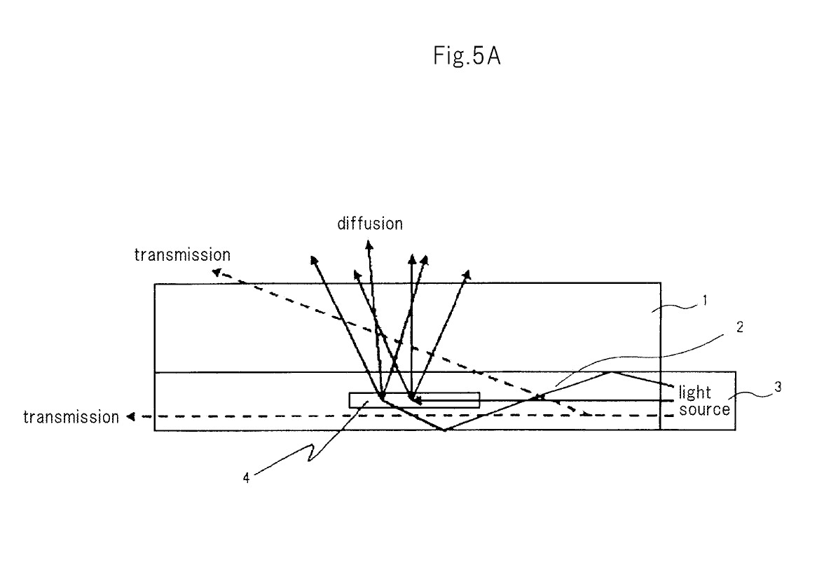

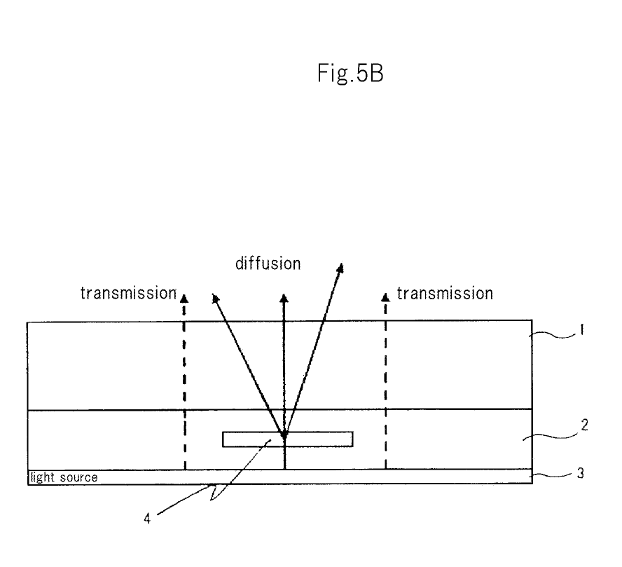

FIG. 2A is an external oblique perspective view of a mobile terminal according to the present exemplary embodiment. FIG. 2B, FIG. 3, and FIG. 4 are oblique perspective views that illustrate a basic configuration of a key operation portion of the mobile terminal according to the present exemplary embodiment. FIG. 5 is a side sectional view of a key operation portion for explaining transmission and diffusion of light from a light source.

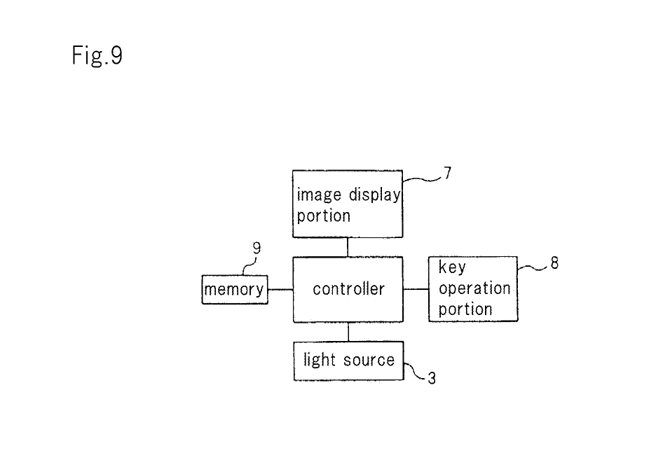

Mobile terminal 20 comprises housing 10, image display portion 7, key operation portion 8, and memory 9. Light source 3, controller 8, and memory 9 (see FIG. 9) are housed inside housing 10. In addition to controlling various functions of mobile terminal 20, controller 8 controls displaying input keys 4a for input to key operation portion 8, displaying an image on image display portion 7 in response to an input from input keys 4a, and the on and off states of light source 3. Various setting values and the like are stored in memory 9.

Image display portion 7 comprises an LCD or an EL (electro luminescent) display or the like. For example, image display portion 7 displays function selection keys, a phone book, text of an e-mail, an image relating to an application, and the like. As an image relating to an application, for example, when mobile terminal 20 is equipped with a camera function, an image that is recognized by a camera is displayed.

Key operation portion 8 comprises touch panel 1 that is laminated on transmission/diffusion switchable film 2. Key operation portion 8 displays image pattern 4 in accordance with a function, and is configured to enable input with image pattern 4 employed as input keys 4a. As described later, numerals for dialing, characters for e-mail creation, and operation keys for an application and the like are displayed as input keys 4a.

Regarding transmission/diffusion switchable film 2, for example, a liquid crystal material whose orientation is changed by application of a voltage and a polymeric material for randomly orienting liquid crystal when a voltage is not applied are encapsulated in a transparent film of acryl or the like. For example, PNLC (Polymer Network Liquid Crystal) can be applied for transmission/diffusion switchable film 2. PNLC includes a type that transmits light in a state in which a voltage is applied and diffuses light in a state in which a voltage is not applied, or a type that diffuses light in a state in which a voltage is applied and transmits light in a state in which a voltage is not applied.

Light source 3 may be disposed as a linear light source on a side surface of transmission/diffusion switchable film 2 as shown in FIG. 3 and FIG. 5A, or may be disposed as a surface light source on a rear surface of transmission/diffusion switchable film 2 as shown in FIG. 4 and FIG. 5B. In this connection, when light source 3 is provided on the rear surface of transmission/diffusion switchable film 2, the thickness of light source 3 will be added to the thickness of key operation portion 8. However, as long as the increase in thickness is of an extent that does not influence the thickness of the mobile terminal overall, a configuration in which light source 3 is provided on the rear surface of transmission/diffusion switchable film 2 has the merit that the entire screen can be uniformly illuminated. An LED or the like is used for light source 3. Light source 3 may also be a linear light source, or may be a point light source disposed at several places (one or more places) on the circumference in accordance with the image that is to be represented.

Image pattern 4 is formed on transmission/diffusion switchable film 2. In a state in which a voltage is applied, image pattern 4 cannot be visually recognized since a light from light source 3 is transmitted through image pattern 4. In a state in which a voltage is not applied, image pattern 4 can be visually recognized since light is diffused at image pattern 4.

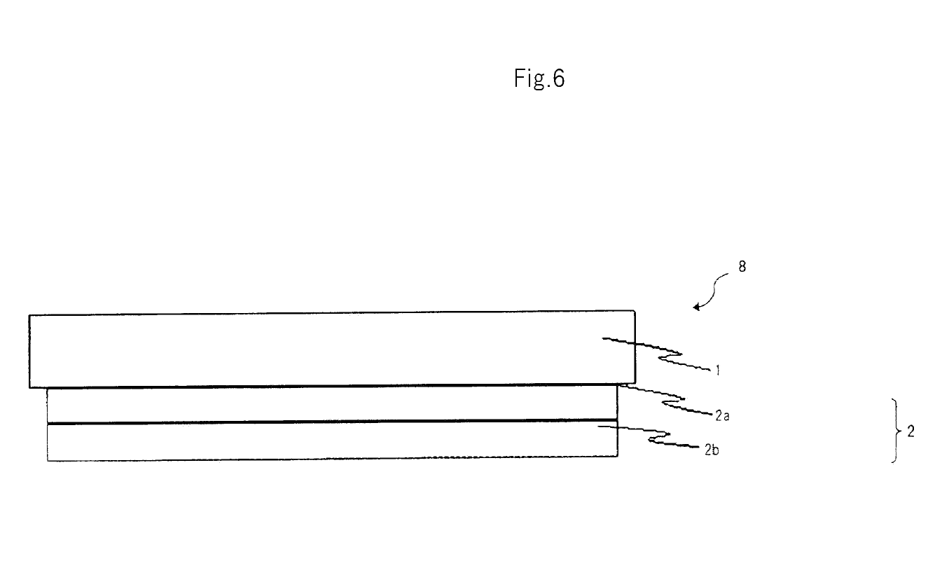

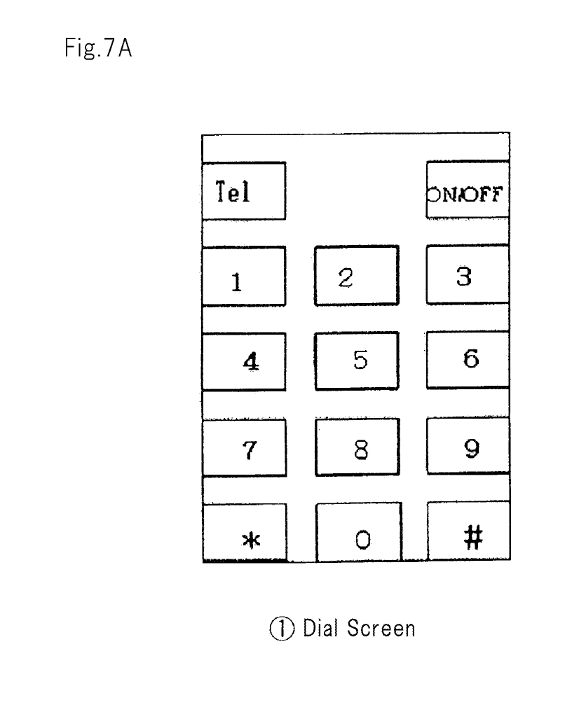

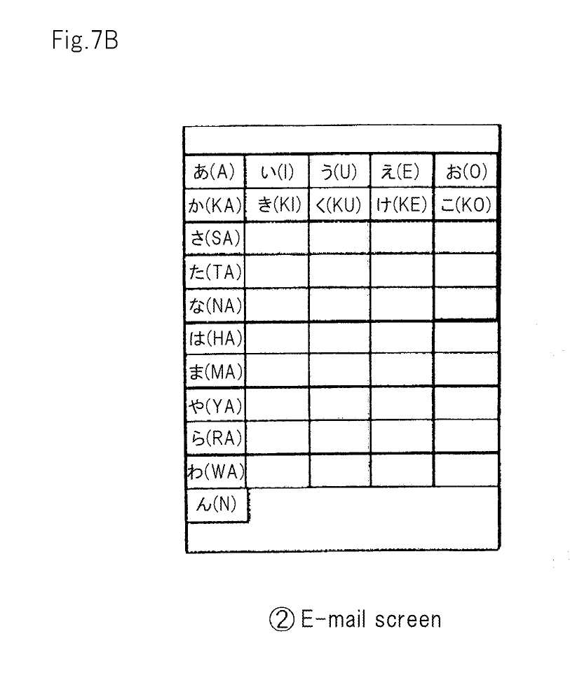

When there are several kinds of complex image patterns 4 and it is not possible to make all image patterns 4 corresponding to only one kind of transmission/diffusion switchable film 2, then transmission/diffusion switchable film 2 may comprise a plurality of layers. By using transmission/diffusion switchable film 2 comprising a plurality of layers, it is possible to express several image patterns 4 on mobile terminal 20 in accordance with the use of key operation portion 8. FIG. 6 shows a side sectional view of key operation portion 8 that includes a transmission/diffusion switchable film comprising a plurality of transmission/diffusion switchable layers. In FIG. 6, an example is illustrated in which transmission/diffusion switchable film 2 comprises first transmission/diffusion switchable layer 2a and second transmission/diffusion switchable layer 2b. Different image patterns 4 are previously formed on first transmission/diffusion switchable layer 2a and second transmission/diffusion switchable layer 2b, respectively. For example, image pattern 4 of a dial screen as shown in FIG. 7A is previously formed on first transmission/diffusion switchable layer 2a, and image pattern 4 of an e-mail screen as shown in FIG. 7B is previously formed on second transmission/diffusion switchable layer 2b. Although the example is illustrated in FIG. 7B in which Japanese characters are displayed as image pattern 4 of the e-mail screen, naturally the present invention is not limited thereto, and alphabet characters or the like may be displayed as image pattern 4 of the e-mail screen.

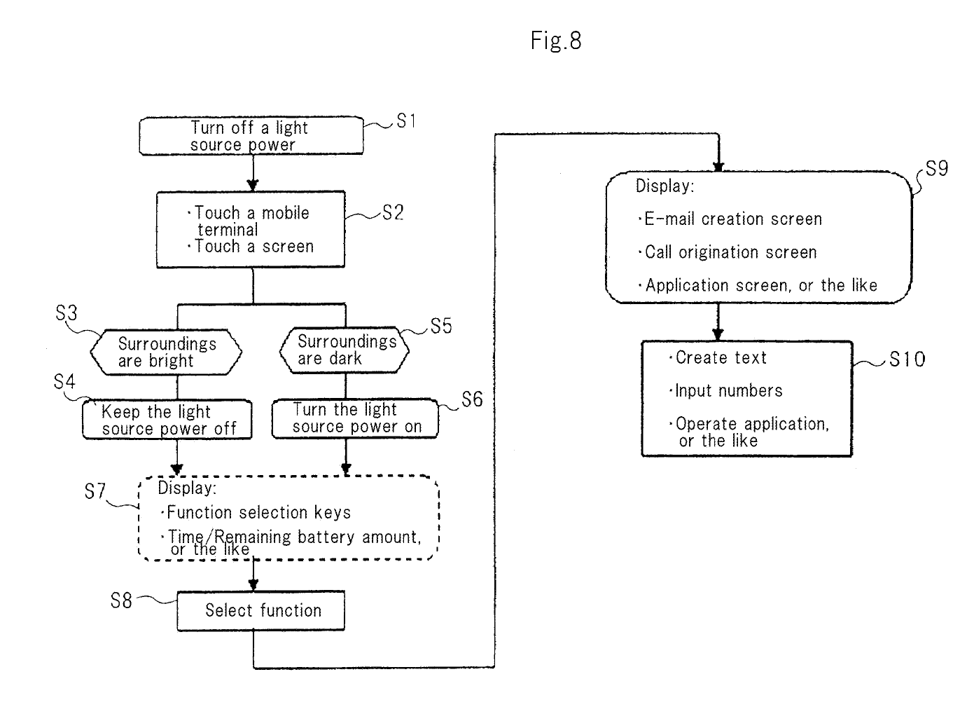

Next, operations of the key operation portion of the mobile terminal of the present exemplary embodiment are described using the flowchart shown in FIG. 8 and the control block diagram shown in FIG. 9.

When mobile terminal 20 is not being operated, the power of light source 3 is in an “off” state (step S1). At that time, a configuration may be adopted such that controller 8 displays a screen that can adequately exhibit an illumination effect, such as a screen saver, on transmission/diffusion switchable film 2. Further, although light source 3 is in an “off” state when mobile terminal 20 is not being operated, a setting that causes light source 3 to light when operations are started may be stored in memory 9.

When a user touches mobile terminal 20, image display portion 7, or key operation portion 8, the display of transmission/diffusion switchable film 2 is switched from a state in which an illumination effect is exhibit to a state in which a function selection screen is displayed (steps S2, S7).

In this case, when the surroundings are bright (step S3), controller 8 keeps the power of light source 3 turned off (step S4). In contrast, when the surroundings are dark (step S5), controller 8 turns on the power of light source 3 (step S6). This setting to turn light source 3 on/off may be executed by detecting a peripheral external light using an illumination sensor or the like mounted in mobile terminal 20, storing a control pattern that turns off light source 3 when the surroundings are bright and turns on light source 3 when the surroundings are dark in memory 9, and performing the relevant control with controller 8 based on the control pattern. A configuration may also be adopted in which the user can adjust the brightness of light source 3 on their own in accordance with the surrounding illumination environment. Switching light source 3 on/off in accordance with the surrounding light effectively utilizes the merits of the reflectance properties of image pattern 4 of transmission/diffusion switchable film 2, and an energy saving effect can be expected as a result.

When the display of key operation portion 8 is switched to the function selection screen, a time/remaining battery amount and the like are displayed in addition to function selection keys as input keys 4a on the screen of key operation portion 8 (step S7). As function selection keys, for example, selection keys for call origination, e-mail creation, application utilization and the like are displayed.

The user selects a function the user wants to display by touching the relevant key from among the displayed function selection keys (step S8).

When the user selects a function, controller 8 displays dedicated keys for the selected function on key operation portion 8. For example, when call origination is selected, controller 8 displays a dial screen on which numerals are arrayed as shown in FIG. 7A on key operation portion 8. In contrast, when e-mail creation is selected, controller 8 displays an e-mail screen on which characters are arrayed as shown in FIG. 7B on key operation portion 8. Further, when an application of mobile terminal 20 is selected, controller 8 displays operation keys suited to operation of that application on key operation portion 8.

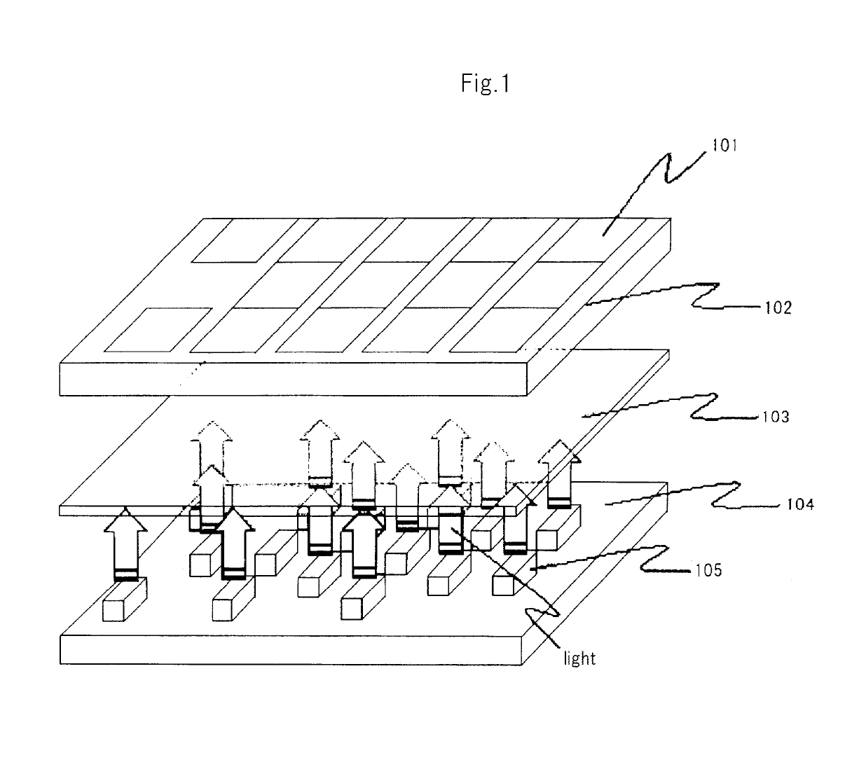

According to the key operation portion of the related art shown in FIG. 1, input of characters must be performed using a dial screen on which numerals are arrayed, even when creating text for e-mail use. It is therefore not easy to input characters using the key operation portion of the related art. In contrast, according to mobile terminal 20 of the present exemplary embodiment, since a screen for character input is displayed on key operation portion 8 at a time of e-mail creation, creation of an e-mail is simple (step S10).

In addition to the above described configuration, according to the present invention a configuration can also be adopted which utilizes light that escapes from a side surface portion of transmission/diffusion switchable film 2.

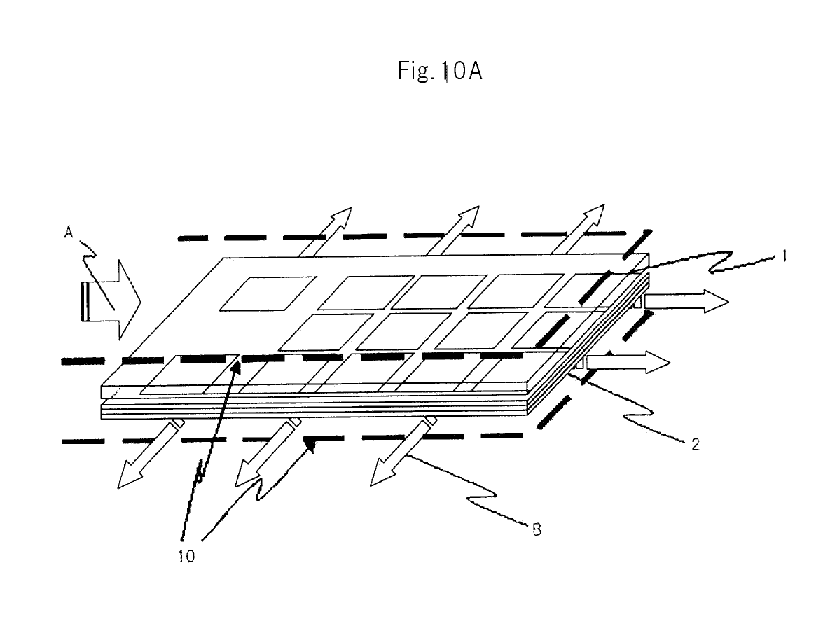

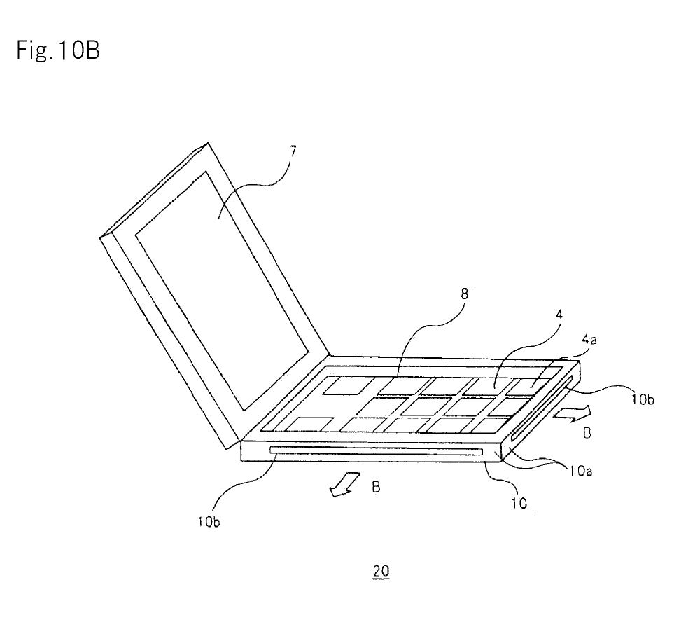

FIG. 10A shows a schematic view of the vicinity of a key operation portion of a mobile terminal in a case in which escaping light is utilized as illumination light. FIG. 10B shows an oblique perspective view of a mobile terminal of the present exemplary embodiment in which windows are formed in side surfaces thereof. In this connection, in FIG. 10A, housing 10 of the mobile terminal is indicated by broken lines.

As shown in FIG. 10B, side surfaces 10a of mobile terminal 20 are provided with transparent windows 10b. Key operation portion 8 that includes a touch panel and transmission/diffusion switchable film 2 is housed inside housing 10.

When light from a side surface of the key operation portion (left side in FIG. 10A) is incident in the direction of arrow A, the light passes through the inside of transmission/diffusion switchable film 2 and a part of the light is diffused at image pattern 4 of transmission/diffusion switchable film 2. Further, although one part of the light penetrates to the front and rear of the screen, a part of the light also escapes from side surfaces of transmission/diffusion switchable film 2 (arrows B in FIG. 10A). Therefore, by positioning side surfaces of transmission/diffusion switchable film 2 at side surface portions of housing 10, or by providing transparent windows 10b in side surfaces 10a of housing 10, light that escapes in the direction of arrows B from the side surfaces of transmission/diffusion switchable film 2 can be utilized as illumination light of the side surfaces of housing 10.

As described in the foregoing, the present invention provides the advantages described below.

A first advantage of the present invention is that since a pattern of keys to be displayed can be changed according to the function, a mobile terminal that has excellent operability and offers sufficient changes in appearance can be provided.

A second advantage of the present invention is that an illumination effect can be exhibited by combining transmission/diffusion switchable film 2 and light source 3 such as a colorful LED.

A third advantage of the present invention is that since a device configuration is adopted that employs thin films as main constituents, mobile terminal 20 can be made thin.

A fourth advantage of the present invention is that since the invention utilizes light guiding properties of transmission/diffusion switchable film 2, it is possible to reduce the number of LED lights as light source 3 and thus decrease costs and power consumption.

Further, the present invention obtains the above described first to fourth advantages by using touch panel 1 and transmission/diffusion switchable film 2 provided in key operation portion 8. That is, since touch panel 1 is not provided on image display portion 7, image display portion 7 is not subjected to a deterioration in the display properties thereof such as a decrease in brightness or a deterioration in chromaticity that occurs when light passes through touch panel 1. Hence, the present invention can adequately exploit the specifications of the properties of the LCD in image display portion 7.

Although the invention of the present application has been described above referring to an exemplary embodiment, it should be understood that the invention of the present application is not limited to the exemplary embodiment described above. Various changes and modifications that will be understood by one skilled in the art can be made to the configuration or details of the invention of the present application without departing from the spirit or scope of the invention.

This application is based upon and claims the benefit of priority from the prior Japanese Patent Application No. 2007-204182, filed in Japan on Aug. 6, 2007; the entire contents of which are incorporated herein by reference.

1. A mobile terminal comprising:
an image display portion that displays an image; and
a key operation portion which displays a image pattern in accordance with a function and which enables an input operation that uses the image pattern as input keys; wherein the key operation portion includes a transmission/diffusion switchable film that transmits or diffuses a light from a light source.

2. The mobile terminal according to claim 1, wherein the key operation portion comprises a touch panel that is provided in a laminated manner on the transmission/diffusion switchable film.

3. The mobile terminal according to claim 1, comprising a plurality of the transmission/diffusion switchable films, wherein image patterns that is displayed by each of the transmission/diffusion switchable films are different.

4. The mobile terminal according to claim 1, wherein:
the mobile terminal is a mobile phone; and
as the image pattern,
a dial screen for call origination is displayed when a call origination function is selected,
a screen on which characters for e-mail creation are arrayed is displayed when an e-mail creation function is selected, and
a operation key for the application are displayed when an application function is selected.

5. The mobile terminal according to claim 1, wherein light of the key operation portion is used as illumination.

6. The mobile terminal according to claim 5, comprising a transparent window on a side surface of a housing of the mobile terminal.
